(19) United States
(12) Patent Application Publication
(10) Pub. No.: US 2013/0111278 A1
(43) Pub. Date: May 2, 2013

(54) MULTI-CHANNEL APPARATUS AND HARDWARE PHASE SHIFT CORRECTION METHOD THEREFOR

(71) Applicants: Fu-Chiang Jan, Jhuolan Township (TW); Wei-Cheng Lu, Chiayi City (TW); Chih-Yu Chang, Taichung City (TW)

(72) Inventors: Fu-Chiang Jan, Jhuolan Township (TW); Wei-Cheng Lu, Chiayi City (TW); Chih-Yu Chang, Taichung City (TW)

(73) Assignee: INDUSTRIAL TECHNOLOGY RESEARCH INSTITUTE, Hsinchu (TW)

(21) Appl. No.: 13/474,311

(22) Filed: May 17, 2012

(30) Foreign Application Priority Data
Oct. 31, 2011 (TW) 100139657

(51) Int. Cl. G06F 11/07

(52) U.S. Cl. 714/700; 714/E11.023

(57) ABSTRACT

A hardware phase shift correction method for a multi-channel apparatus is provided. The method includes the following steps. A multi-channel apparatus including a plurality of analog circuits is provided, wherein the multi-channel apparatus transmits an analog signal and receives an echo signal. In a receiving path test mode, a plurality of first test signals are received. The first test signals are enabled to pass through a receiving path of the multi-channel apparatus, and converted to a plurality of test data. In response to the test data corresponding to the first test signals, phase shift correction for the channels is performed.

This application claims the benefit of Taiwan application Serial No. 100139657, filed Oct. 31, 2011, the disclosure of which is incorporated by reference herein in its entirety.

### BACKGROUND

1. Technical Field

The disclosed embodiments relate in general to a multi-channel apparatus and error correction method, and more particularly to a multi-channel apparatus and hardware phase shift correction method therefor.

2. Description of the Related Art

Sonography is an in-depth scanning technique performed on biological tissues by use of ultrasonic waves. Based on a characteristic that ultrasonic waves are reflected when encountering an object, the reflected ultrasonic waves are received and converted to image information representing different depth characteristics of a tissue. For example, by utilizing probes of different dimensions, a tissue may be scanned in different dimensional spaces to achieve an image formation of sectional images (tomography) inside the tissue.

An ultrasonic wave is a kind of mechanical wave, whose penetration depth can be determined by a frequency of a probe. In addition, the ultrasonic wave is not ionizing radiation. When the mechanical wave is transmitted to the material inside a tissue, molecules of the tissue will merely vibrate and then quickly restore back to their original states. By leaving the molecules unchanged, hazards accompanying a test performed by ultrasonic waves are minimal. Accordingly, ultrasonic scanning is prevalent in the medical field.

In a multi-channel apparatus of the above ultrasonic system, in order to scan and receive an echo, a transmission timing of a transducer, e.g., different elements in an ultrasonic probe, is controlled to control positions and depths of beamforming, so as to detect different positions and depths inside the tissue by an ultrasonic beam. To detect and correct phase shift caused after ultrasonic waves enter an object under test, in certain prior art, reflected ultrasonic waves are IQ modulated after ultrasonic waves enter the object under test to determine a correct time difference of each channel and thus correct the time difference. Therefore, each channel needs a demodulation circuit.

### SUMMARY

The disclosure is directed to a hardware phase shift correction method for a multi-channel apparatus and a multi-channel apparatus capable of hardware phase shift correction.

According to one embodiment, a multi-channel apparatus is provided. The multi-channel apparatus includes a digital-to-analog conversion unit, an amplification and gain control unit, an analog-to-digital conversion unit, a switching unit and a digital transmitting and receiving control unit. The digital-to-analog conversion unit generates a plurality of output signals. The amplification and gain control unit receives a plurality of input signals. The analog-to-digital conversion unit is coupled to the amplification and gain control unit. The switching unit, coupled between the digital-to-analog conversion unit and the amplification and gain control unit, includes a plurality of channels for outputting the plurality of output signals or receiving the plurality of input signals. The digital transmitting and receiving control unit is coupled between the digital-to-analog conversion unit and the analog-to-digital conversion unit. In a receiving path test mode, the multi-channel apparatus controls the digital-to-analog conversion unit to enter the receiving path test mode, and the channels of the switching unit to receive a plurality of first test signals. In response to a plurality of test data, corresponding to the plurality of first test signals, outputted from the analog-to-digital conversion unit, the digital transmitting and receiving control unit performs phase shift correction for the plurality of channels of a receiving path of the multi-channel apparatus.

According to another embodiment, a hardware phase shift correction method for a multi-channel apparatus is provided. The method includes the following steps. A multi-channel apparatus is provided, which includes a digital-to-analog conversion unit, an amplification and gain control unit, an analog-to-digital conversion unit, a switching unit and a digital transmitting and receiving unit. The digital transmitting and receiving unit is coupled between the digital-to-analog conversion unit and the analog-to-digital conversion unit. The switching unit is coupled between the digital-to-analog conversion unit and the amplification and gain control unit. The amplification and gain control unit is coupled between the switching unit and the analog-to-digital conversion unit. In a receiving path test mode, the digital-to-analog conversion unit is controlled to enter the receiving path test mode. A plurality of first test signals is received via channels of the switching unit. In response to a plurality of test data outputted by the analog-to-digital conversion unit, phase shift correction for the plurality of channels is performed by the digital transmitting and receiving control unit, wherein the plurality of test data correspond to the plurality of first test signals.

According to yet another embodiment, a hardware phase shift correction method for a multi-channel apparatus is provided. The method includes the following steps. A multi-channel apparatus is provided, wherein the multi-channel apparatus includes a plurality of analog circuits, the multi-channel apparatus for transmitting an analog signal and receiving an echo signal. In a receiving path test mode, a plurality of first test signal is received. The plurality of first test signals are enabled to pass through a plurality of channels of a receiving path of the multi-channel apparatus, and the plurality of first test signals are converted to a plurality of test data corresponding to the plurality of first test signals. In response to the plurality of test data corresponding to the plurality of first test signals, phase shift correction for the plurality of channels is performed.

### BRIEF DESCRIPTION OF THE DRAWINGS

FIG. 1 is a block diagram of a multi-channel apparatus according to one embodiment.

FIG. 2 is a block diagram of a digital transmitting and receiving control unit according to one embodiment.

FIG. 3 and FIG. 4 are block diagrams of a multi-channel apparatus according to yet other embodiments.

FIGS. 5A and 5B are flowcharts of a hardware phase shift correction method for a multi-channel apparatus according to one embodiment.

FIG. 6 illustrates an embodiment of performing phase shift correction for a plurality of channels, as indicated in FIG. 5A or 5B, in a flowchart form.

FIG. 7 is a schematic diagram of capturing N sets of data of a plurality of channels in a test mode.

FIG. 8 is a block diagram of an ultrasonic system according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Embodiments of a hardware phase shift correction method for a multi-channel apparatus and a multi-channel apparatus capable of hardware phase shift correction shall be given below.

FIG. 1 shows a block diagram of a multi-channel apparatus according to an embodiment. A structure of a multi-channel apparatus 100 in FIG. 1 may be implemented as basis for an apparatus or equipment having multi-channel input or output signals, e.g., a medical apparatus such as an ultrasonic scanner or various apparatuses or equipments using similar structures. The multi-channel apparatus 100 includes a digital-to-analog converter 110, a switching unit 120, an amplification and gain control unit 130, an analog-to-digital converter 140, and a digital transmitting and receiving control unit 150. In a test mode of the multi-channel apparatus 100, the digital transmitting and receiving control unit 150 is capable of performing phase shift correction for channels internally (i.e., with respect to hardware) along a receiving path or a transmitting path of the multi-channel apparatus 100 to improve hardware phase shift.

In a normal operating mode, the multi-channel apparatus 100, through the switching unit 120, receives or transmits a plurality of multi-channel signals SCH, e.g., signals SCH of 32, 64 or 128 channels. With respect to a receiving path of the multi-channel apparatus 100, for example, the multi-channel apparatus 100 receives the multi-channel signals SCH (e.g., a plurality of multi-channel analog signals) through the receiving path formed by analog circuits including the switching unit 120, the amplification and gain control unit 130 and the analog-to-digital conversion unit 140. The multi-channel signals SCH are converted to digital multi-channel signals, which are processed by the digital transmitting and receiving control unit 150 to generate an output signal SBF. Further, as far as a transmitting path is concerned, signals to be transmitted (e.g., a digital signal) are outputted by the digital transmitting and receiving control unit 150 through the transmitting path including the digital-to-analog conversion unit 110 and the switching unit 120, and are transmitted as multi-channel signals SCH (e.g., multi-channel analog signals) by a transducer. The above operating mode may be applied to a medical scanning apparatus such as an ultrasonic system, with details of an example of an ultrasonic system to be described shortly. Timing control and logic for beamforming of beams transmitted for scanning different depths and positions of an object are achieved by the transmitting and receiving control unit 150. To restore information of different depths and positions of a scanned object, the digital transmitting and receiving control unit 150 also performs timing control and logic conversion for beamforming of received waves transmitted by the analog-to-digital conversion unit 140. A scan line in a two-dimensional space for the scanned object is restored, and is represented by the signal SBF that is then outputted to a subsequent circuit for further processing.

As discussed above, under a normal operating mode, the received multi-channel signals SCH are processed by the above receiving path formed by analog circuits. The received multi-channel signals SCH further undergo beamforming via the digital transmitting and receiving control unit 150 to obtain time difference information of the different channels, so as to restore different depth information for generating the signal SBF. However, phase shift between signal transmissions of different channels may occur due to non-ideal factors including errors in analog processing circuit designs and layout path lengths, errors in conversion timings between different channels in the analog-to-digital conversion unit, unequal path lengths of high-speed digital transmitting paths and issues in digital synthesis. The phase shift is likely to lead to faulty beamforming such that peaks and valleys of signals in the channels counteract with one another to degrade the scanning quality in the subsequent circuit stages of the apparatus.

Apart from the normal operating mode, the multi-channel apparatus 100 of this embodiment further supports a test mode for performing phase shift correction for the channels of the receiving path or the channels of the transmitting path. In one embodiment, the digital transmitting and receiving control unit 150 is coupled between the digital-to-analog conversion unit 110 and the analog-to-digital conversion unit 140. In a receiving path test mode, the multi-channel apparatus 100 disables the digital-to-analog conversion unit 110, and receives a plurality of first test signals ST1 of the channels via the switching unit 120. In response to a plurality of test data outputted from the analog-to-digital conversion unit 140, the digital transmitting and receiving control unit 150 performs phase shift correction for the channels of the receiving path. The test data correspond to the first test signals ST1. For example, the first test signals ST1 are a predetermined test pattern such as in-phase multi-channel waveform signals, multi-channel waveform signals having a constant phase relationship, or other test patterns applicable to phase shift correction.

In another embodiment, the multi-channel apparatus 100 further supports a transmitting path test mode. In the transmitting path test mode, the multi-channel apparatus 100 controls the digital-to-analog conversion unit 110 to output a plurality of second test signals ST2, and outputs the second test signals ST2 via the switching unit 120 to the amplification and gain control unit 130. In response to a plurality of test data outputted from the analog-to-digital conversion unit 140, the digital transmitting and receiving control unit 150 performs phase shift correction for the channels of the transmitting path. The test data correspond to the second test signals. In yet another embodiment, after performing phase shift correction for the receiving path, phase shift correction for the channels of the transmitting path may be performed to correct phase shift resulted by hardware errors on the receiving path and the transmitting path. Thus, in the implementation of the multi-channel apparatus 100 under a normal operating mode for probing, phase shift of internal hardware may be improved to enhance overall scanning quality.

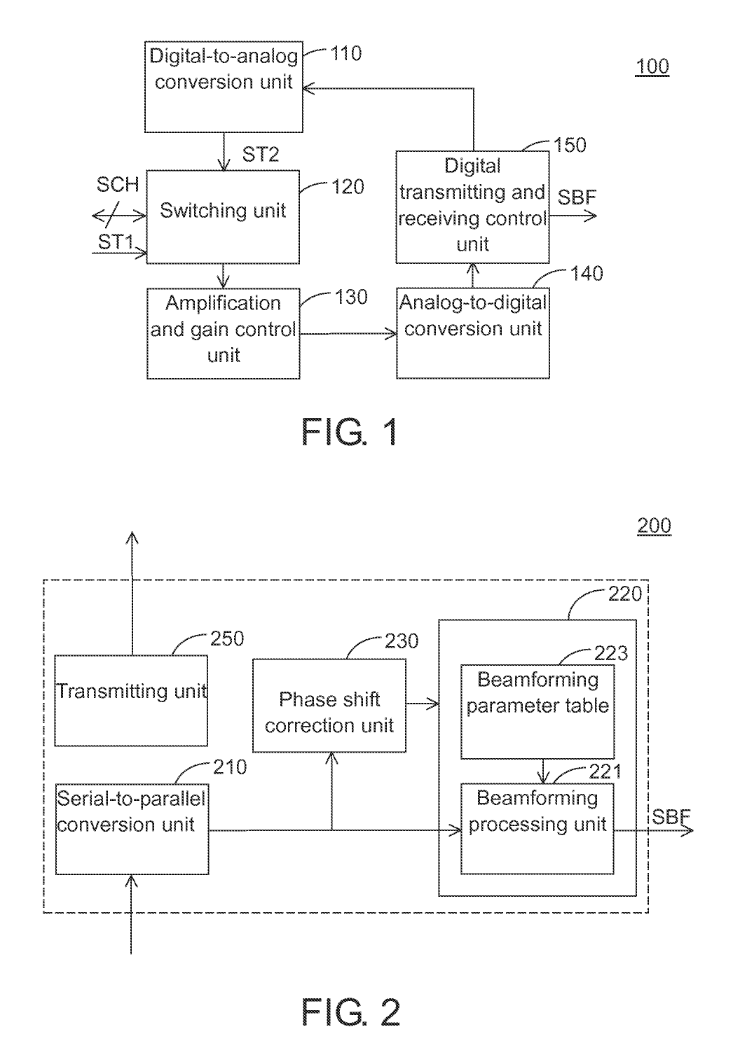

FIG. 2 shows a block diagram of a digital transmitting and receiving control unit according to one embodiment. A digital transmitting and receiving control unit 200 includes a serial-to-parallel conversion unit 210, a digital beamforming unit 220 and a phase shift correction unit 230. The serial-to-parallel conversion unit 210 is coupled to a previous-stage analog circuit, e.g., the analog-to-digital conversion unit 140 in FIG. 1. For example, the analog-to-digital conversion unit 140 serially outputs analog-to-digital converted results therefrom. The digital beamforming unit 220, coupled to an output of the serial-to-parallel conversion unit 210, outputs a beamforming signal SBF. The phase shift correction unit 230 is coupled to the output of the serial-to-parallel conversion unit 210 and the digital beamforming unit 220. In response to the test data outputted from the analog-to-digital conversion unit 140, the phase shift correction unit 230 adjusts the beamforming signal to reduce a hardware-resulted error. Depending on whether the test mode is for the receiving path or the transmitting path, the phase shift correction unit 230 is capable of performing phase shift correction for the corresponding channels.

Referring to FIG. 2, in one embodiment, the digital beamforming unit 220 includes a beamforming processing unit 221. In response to beamforming parameters (e.g., indicated or recorded by a table) of the channels and the output signals of the serial-to-parallel conversion unit 210, the beamforming processing unit 221 outputs the beamforming signal SBF. According to a result of phase shift correction performed by the phase shift correction unit 230 and the beamforming parameters of the channels, the beamforming 221 further adjusts the beamforming signal SBF. In one embodiment, the beamforming parameters may be established into a parameter table 223 implemented by a memory. For example, the digital beamforming unit 220 is implemented by an processing unit such as a microprocessor, a digital signal processor (DSP), an application-specific integrated circuit (ASIC) or a field programmable gate array (FPGA). For example, the beamforming parameter table is stored in a built-in memory in the operational circuit or an external memory, or is presented in a code. In other embodiments, the result of phase shift correction, e.g., a phase correction value, may be utilized for modifying phase-associated parameters of the channels in the beamforming parameter table 223. Alternatively, in other embodiments, the beamforming processing unit 221 may adjust the beamforming signal SBF in a normal operating mode according to the result of phase shift correction. Therefore, the circuit in FIG. 2 is for illustrative purposes only, and the implementation of the digital beamforming unit 220 is not limited to the description above. The digital transmitting and receiving control unit 200 may further include a transmitting unit 250 for scanning beamforming control of waves transmitted by an object under test in a normal operating mode. In another embodiment, the phase shift correction unit 230 and the digital beamforming unit 220 may receive the parallel multi-channel data outputted by the analog-to-digital conversion unit 140, and are not limited to the implementations in FIG. 2.

A principle of the hardware structure disclosed by above embodiment is that, the hardware structure supports a test mode capable of detecting phase shift between channels to further perform hardware phase shift correction. Thus, before actual scanning or probing in a normal operating mode, phase shift correction is performed without affecting a beamforming operational structure of the digital transmitting and receiving control unit 200 to thereby enhance overall scanning quality. As such, the multi-channel apparatus may be applied to various digital beamforming operational approaches including delay-and-sum, weight-sum and filter-and-sum.

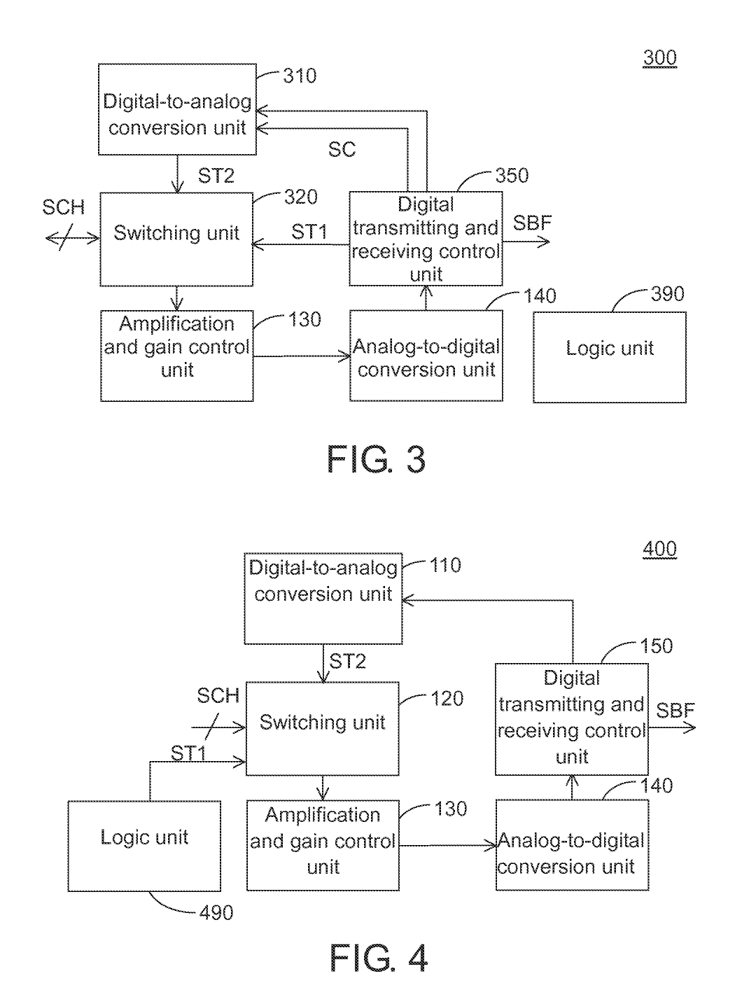

Therefore, the hardware structure of the multi-channel apparatus 100 supporting a test mode may be implemented in other embodiments as shown in FIGS. 3 and 4, and is not limited to the above embodiment.

Referring to FIG. 3, a main difference between a multi-channel apparatus 300 and the multi-channel apparatus 100 in FIG. 1 is that, a digital transmitting and receiving control unit 350 is coupled to a switching unit 320, and outputs the first test signals ST1 in a receiving path test mode. In the multi-channel apparatus 300 of another embodiment, in a receiving path test mode, the digital transmitting and receiving control unit 350 controls the digital-to-analog conversion unit 310 to enter the test mode. For example, the digital transmitting and receiving control unit 350 triggers the digital-to-analog conversion unit 310 to enter the test mode by a control signals SC, and so operations of the switching unit 320 are left unaffected. In yet another embodiment, the multi-channel apparatus 300 further includes a logic unit 390 implemented by a common logic element or a circuit such as a microprocessor, a DSP, an ASIC or an FPGA. In the receiving path test mode, the logic unit 390 controls the units of the receiving path, e.g., the digital-to-analog conversion unit and the digital transmitting and receiving control unit, to perform phase shift correction.

In another embodiment based on FIG. 3, in the transmitting path test mode, the digital transmitting and receiving control unit 350 controls the digital-to-analog conversion unit 310 to output the second test signals ST2. In another embodiment, in the transmitting path test mode, the logic unit 390 controls the units of the transmitting path, e.g., the digital-to-analog conversion unit 310 and the digital transmitting and receiving control unit 350 or the switching unit 320, to perform phase shift correction.

Referring to FIG. 4, a main difference between a multi-channel apparatus 400 and the multi-channel apparatus 100 in FIG. 1 is that, the multi-channel apparatus 400 includes a logic unit 490 implemented by a common logic element or a circuit such as a microprocessor, a DSP, an ASIC or an FPGA. In the receiving path test mode, the logic unit 490 outputs a plurality of first test signals ST1. In other embodiments, the logic unit 490 controls the units of the receiving path in the receiving path test mode to perform phase shift correction, and controls the units of the transmitting path in the transmitting path test mode to perform phase shift correction.

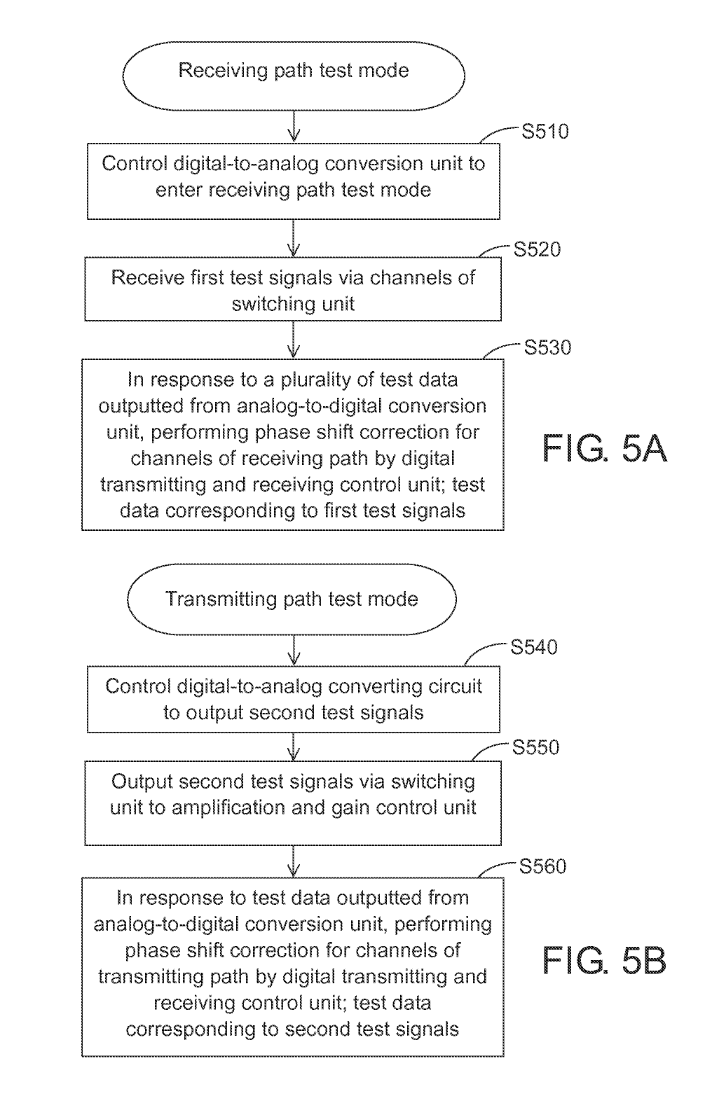

FIGS. 5A and 5B are a flowchart of a hardware phase shift correction method for a multi-channel apparatus. As shown in FIG. 5A, in a receiving path test mode, steps below are performed by the multi-channel apparatus in the embodiments in FIGS. 1, 3 and 4. In step S510, the digital-to-analog conversion unit is controlled to enter a receiving path test mode to coordinate with a process of the test mode. For example, the digital-to-analog conversion unit is disabled or is temporarily suspended from outputting signals. In step S520, the plurality of test signals ST1 are received via the channels of the switching unit. In step S530, in response to a plurality of test data outputted from the analog-to-digital conversion unit, phase shift correction is performed for the channels of the receiving path via the digital transmitting and receiving control unit. The test data correspond to the first test signals ST1. For example, step S520 may be performed according to the embodiment in FIG. 1, 3 or 4.

Referring FIG. 5B, in a transmitting path test mode, steps below are performed by the multi-channel apparatus in the embodiments in FIGS. 1, 3 and 4. In step S540, the digital-to-analog conversion unit is controlled to output a plurality of second test signals ST2. In step S550, the second test signals are outputted to the amplification and gain control unit via the switching unit. In step S560, in response to a plurality of test data outputted from the analog-to-digital conversion unit, phase shift correction is performed for the channels of the receiving path by the digital transmitting and receiving control unit. The test data correspond to the second test signals ST2. In other embodiments, e.g., after performing phase shift correction for the channels of the receiving path as in FIG. 5A, the method further includes steps in FIG. 5B for performing phase shift correction for the channels of the transmitting path.

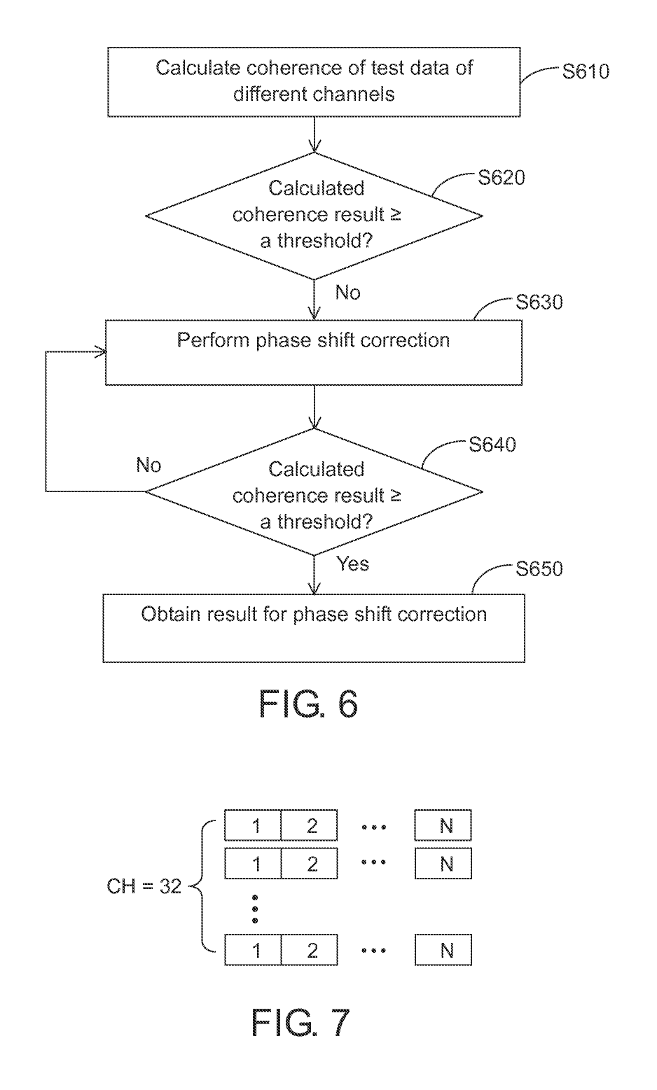

FIG. 6 illustrates an embodiment of performing phase shift correction, as indicated in FIG. 5A or 5B, in a flowchart form. In step S610, coherence of the plurality of test data of the different channels is calculated. For example, a coherence factor is utilized for defining the standard of coherence. In step S620, it is determined whether a calculated coherence result is greater than or equal to a threshold. When the coherence is greater than or equal to the threshold, it means that time differences between the channels are smaller than a predetermined value, and so phase shift correction is not required. When the coherence is smaller than the threshold, it means the time differences between the channels are greater than the predetermined value, and so the method performs a calculating step for channel phase shift correction, as step S630. In step S630, digital data of each channel is adjusted by advancing or postponing by a delayed time value (i.e., a sample index), with an adjustment accuracy being higher than a time difference of an original sample, and the coherence of the adjusted digital data of the channels is calculated. In step S640, it is determined whether the adjusted digital data of the channels is greater than or equal to the threshold. When the coherence is greater than or equal to the threshold, it means that the time differences between the channels are smaller than the predetermined value, and so the advanced or postponed delay time values for the different channels are utilized as correction values or compensations values, i.e., as results of phase shift correction. In an embodiment, for example, the results of phase shift correction are utilized for adjusting the beamforming operation associated with the digital beamforming unit 220 in FIG. 2. In yet another embodiment, for example, the results of phase shift correction are utilized for updating the beamforming parameter table. When the coherence calculated in step S640 is smaller than the threshold, step S630 and associated steps are iterated until the coherence of the adjusted digital data of the channels satisfies the threshold. As shown in FIG. 5650, the results of phase shift correction are obtained. Thus, after the channel time difference correction, the multi-channel apparatus may enter a normal operating mode to perform multi-channel scanning or probing. The multi-channel apparatus may again enter the test mode when later desired.

In the method shown in FIG. 6, as far as determining the coherence of the digital data of the different channels is concerned, approaches for mathematically calculating or adjusting the advanced or postponed time values are not limited. The embodiment is to provide a mechanism for detecting and correcting hardware-resulted channel phase shift to increase scanning accuracy and enhance overall scanning quality.

An example of calculating a coherence factor is to be given below. Assuming the multi-channel apparatus has 32 channels (CH=32), a coherence factor CF is defined as:

$$C F = \frac{{\vert \sum {S}_{i} \vert}^{2}}{\sum {\vert {S}_{i} \vert}^{2}} \qquad Formula ( 1 )$$

Referring to FIG. 7, each block of each of the rows represents N pieces of data of a particular channel, and a number in the block is a sample index. As shown in FIG. 7, each channel may capture N pieces of data for calculating the CF value of the 32 channels according to Formula (I). In Formula (1), a numerator is a square of an absolute value of a sum of the data values of same sample indices of the 32 channels; a denominator is a sum of the squares of the absolute values of the data values of the same sample indices of the 32 channels. The CF value is obtained by dividing the numerator by the denominator. For zero phase shift in the data of the 32 channels, the CF value is 1. The CF value decreases in the occurrence of phase shift in the data of the channels. Accordingly, the CF value defined in Formula (1) may be utilized for the coherence calculation in step S620 or step S640. That is also to say, other definitions of the CF value applicable to coherence judgment may also be implemented.

In the description below, an example of phase shift correction shall be given. Assume a multi-channel apparatus comprises 32 channels each capturing N pieces of data. Referring to FIG. 7, cross correlation is performed on every two neighboring channels to obtain correlation between the two channels (step A). For example, a channel 1 and a channel 2 are a group, and a channel 3 and a channel 4 are a group. For a group without phase shift, the correlation between the two channels of the group is high and so a calculated correlation coefficient is also high. Thus, when the correlation coefficient for a particular group is lower than a predetermined threshold, it is likely that one of the two channels of the group suffers from phase shift (step B). By again performing cross correlation on the two channels with a correlation coefficient lower than the predetermined threshold and channels with a correlation coefficient not lower than the predetermined threshold, which of the two channels with the lower correlation coefficient that suffers from phase shift can be identified (step C). Upon identifying which of the channels needing phase shift correction, the sample index of that channel is advanced or postpone by one shift value, and cross correlation is again performed (step D). In the event that the correlation coefficient is still lower than the threshold at this point, the sample index is further adjusted until the correlation coefficient is higher than the threshold. The final adjustment value is regarded as a result of phase shift correction. In some embodiments, the result of phase shift correction may be recorded for future beamforming operations or directly utilized for modifying the beamforming parameter table.

As observed from the above description, the hardware phase shift correction method for a multi-channel apparatus is not limited to applications of a multi-channel structure. In another embodiment, the method includes steps of: providing a multi-channel apparatus, the multi-channel apparatus including a plurality of analog circuits, and being for transmitting an analog signal and receiving an echo signal; in a receiving path test mode, receiving a plurality of first test signal; enabling the first test signals to pass through channels of a receiving path of the multi-channel apparatus, and converting the first test signals to a plurality of test data; and in response to the test data, performing phase shift correction for the channels of the receiving path. The test data correspond to the first test signals.

According to yet another embodiment, the embodiment of the hardware phase shift correction method for a multi-channel apparatus further includes steps of: in a transmitting path test mode, outputting a plurality of second test signals via a circuit of the analog circuits of a transmitting path of the multi-channel apparatus; enabling the second test signals to pass through the channels of the transmitting path of the multi-channel apparatus, and converting the second test signals to a plurality of test data; and in response to the test data, performing phase shift correction for the channels of the transmitting path. The test data correspond to the second test signals.

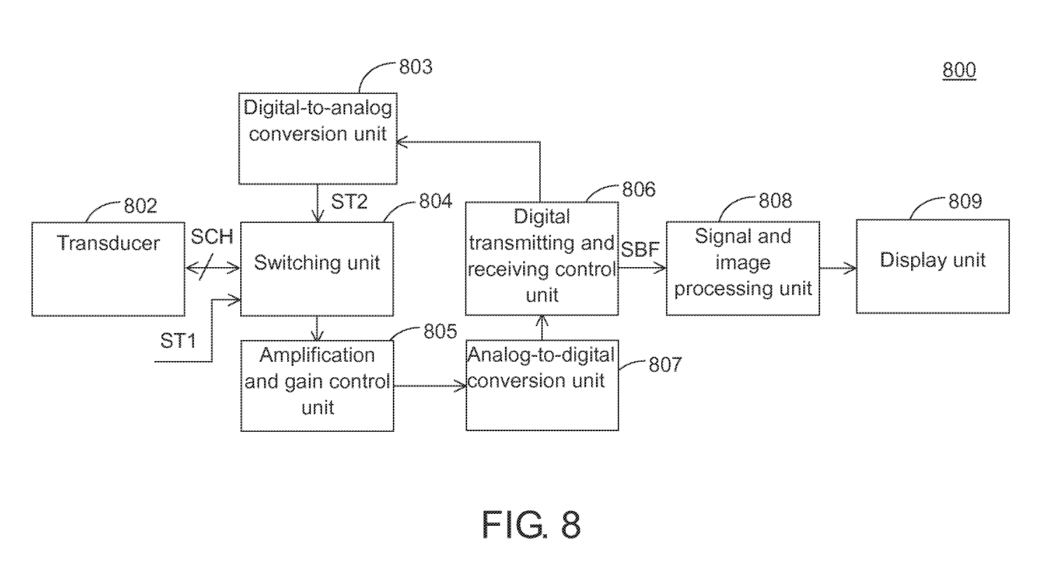

An ultrasonic system taken as an example of a multichannel system shall be described below with reference to the foregoing embodiments. FIG. 8 is a schematic diagram of an ultrasonic system 800. The ultrasonic system 800 includes analog circuits (e.g., 802, 803, 804, 805 and 807), digital signal and image processing units (e.g., 806 and 808), and a display unit 809. A sequence of operations of the system is transmitting, receiving and signal and image processing and display. A transducer 802, e.g., an ultrasonic probe, is formed by piezoelectric material elements, e.g., 64, 128 or 256 elements. To transmit ultrasonic waves, a voltage needs to be applied to the probe 802 and converted to ultrasonic waves that further enter an object under test, e.g., a biological tissue. The voltage that needs to be applied to the probe and converted to ultrasonic that further enters an object under test is handled by a digital-to-analog conversion unit, e.g., a high-voltage generator 803. Also by the probe 802, the ultrasonic waves transmitted and then reflected from the object under test are converted to an electronic signal and transmitted to the analog circuits (805 and 807) for further processing. Since the signal channels of the transmitting and receiving circuits (e.g., 803 and 805) connected to the probe 802 are the same, a switching unit 804 for switching between transmission and reception is needed. The switch provides a path from the high-voltage generator 803 to the probe 802 during transmission, and filters and removes the high-voltage transmitting voltage from entering rear-end small-signal receiving analog circuits (e.g., 805 and 807) during transmission so as to prevent the small-voltage receiving analog circuits (e.g., 805 and 807) from being damaged by the high voltage. An amplification and gain control unit 805 amplifies the received electronic signal, and compensates amplitude attenuation of an echo signal due to different depths of the object (or tissue) under test along with time. The amplified and compensated electronic signal is then converted to a digital signal by the analog-to-digital conversion unit 807, e.g., an analog-to-digital converter.

Beamforming control timing and logic of ultrasonic waves transmitted for scanning different depths and positions of the object under test are handled by a digital transmitting and receiving control unit 806. To restore information of the different depths and positions of the object under test, the digital transmitting and receiving control unit 806 also performs beamforming control timing and logic conversion of the received digital signal transmitted from an ADC 807. A scan line of the object under test in a two-dimensional space is restored and transmitted to a subsequent signal and image processing unit 808. From the digital signal of the scan line, the signal and image processing unit 808 restores characteristic information of the object under test as intended to observe. The signal and image processing unit 808 further converts all the scan lines of the object under test in the two-dimensional space to image information, which is then transmitted to the subsequent display unit 809.

For example, the digital transmitting and receiving control unit 806 is implemented as the embodiment in FIG. 2. In a normal operating mode, a beamforming control timing table and a transmission sequence order of the ultrasonic waves transmitted for scanning the object under test are handled by the transmitting unit 250. By controlling the transmission sequence of the different elements in the ultrasonic probe, positions and depths of beamforming can be controlled to achieve detection of different positions and depths of the object under test by utilizing ultrasonic waves.

Due to the timing controls on the different elements during transmission, between the ultrasonic waves reflected from the object under test are different time differences. That is, time points at which the reflected ultrasonic waves reach the elements are different. The reflected ultrasonic waves received by the different elements are converted to electronic signals, processed by the amplification and gain control unit 805, and then converted to digital signals by the ADC. Since the number of elements may be 64, 128 or 256, a common ADC resolution is as high as 12-bit, and an analog-to-digital sampling frequency is set to at least greater than twice of an operating frequency of the probe, the responded digital data are not only large in amount but also fast in speed. As a result, a conventional parallel transmitting circuit for transmitting such large and fast digital data is too large in volume and costly. Therefore, in this embodiment, the converted digital data is transmitted to the subsequent digital transmitting and receiving control unit 806 through serial transmission to reduce hardware cost. However, the transmission speed of the serial transmission is relatively increased. The multi-channel high-speed digital serial signals after analog-to-digital conversion are restored to the original analog-to-digital converted digital data after being processed by the serial-to-parallel conversion unit 210. As previously stated, to probe different positions and depths in the object under test, different transmitting timings are applied to different elements in the probe, and so time points at which information of a same object under test are received by the different elements are correspondingly different. That is to say, between the analog-to-digital converted digital data of the channels are different time differences. In other words, information of a same tissue may be obtained by different elements, and the information obtained by different elements is characterized by having different time differences. Therefore, to restore and retrieve characteristic information of a particular depth of the tissue from the information obtained by different elements, a beamforming function for received beams is needed, e.g., a delay and sum (DAS) operation is needed. This function eliminates the time differences of information received by different elements. More specifically, tissue characteristic information a correct time interval (i.e., a correct sample index) from the digital information received by each of the elements, and the tissue information of all the different elements is added to obtain the characteristic information of the tissue.

To reduce the calculation amount for actual implementations, the time differences may be calculated in advance according to a relationship between positions of the beamforming when transmitting and an ultrasonic transmission time required for restoring different tissue depth information when receiving. The calculated time differences are stored in the beamforming parameter table 223 (a DAS table is adopted in this embodiment). Hence, to restore different tissue characteristics, the beamforming unit 221 (a unit performing DAS operations) is able to obtain a value for eliminating the time differences between different channels by looking up the DAS table 223. In other words, after looking up the table, a correct initial position (i.e., the sample index) can be identified from the digital information of each of the channels. After restoring the characteristic information of the tissue, the digital information of a scan line is completed and transmitted to the subsequent signal and image processing unit 808. From the digital signals of the scan lines, the signal and image processing unit 808 restores characteristic information of the object under test as intended to observe. The signal and image processing unit 808 further converts all the scan lines to image information, which is then transmitted to a subsequent display unit 809.

Therefore, in the channels of different elements, the ultrasonic waves reflected from the tissue all need to be processed by the analog circuits (804, 805 and 807), transmitted via high-speed serial transmission, and converted to digital parallel data that is next transmitted to the beamforming unit 221. The beamforming unit 221 then looks up the time differences of information of different receiving elements to restore different depth information of the tissue. In the occurrence of the aforementioned non-ideal hardware factors, time differences of signal transmission of the channels are caused such that faulty channel information (i.e., sample index) is likely obtained when restoring the tissue information by utilizing the beamforming unit 221. Moreover, erroneous additions or subtractions of signals may further be resulted to evoke counteractions of peaks and valleys of the signals in the channels, thereby leading to a rear-end image forming quality degradation.

In the embodiment in FIG. 8, the digital transmitting and receiving control unit 806 supports the test mode in the above embodiments, and is capable of performing time difference correction for the channels, and a compensation value (or a correct sample index) required after the correction is likely a compensation value for at least one of the channels. For example, the compensation value is utilized for updating the content of the beamforming parameter table 223 in FIG. 2. Alternatively, for example, in a normal operating mode, the beamforming unit 221 adjusts the output signal SBF with reference to the compensation value. Implementations of the test mode of the ultrasonic system 800 may be as described in the methods in FIG. 5A, 5B or 6. It should be noted that the circuit structure in FIG. 8 may also be modified as the embodiments in FIG. 1, 3 or 4.

Embodiments of a hardware phase shift correction method for a multi-channel apparatus and a multi-channel apparatus capable of hardware phase shift correction are as disclosed. In a test mode of the multi-channel apparatus 100, with respect to the internal (i.e., hardware) of the multi-channel apparatus 100, a digital transmitting and receiving control unit performs phase shift correction for the channels of a receiving or a transmitting path to correct hardware phase shift. In an embodiment, the multi-channel system is a medical apparatus or a detection apparatus such as an ultrasonic system, and is capable of improving hardware-induced phase shift to enhance overall image formation quality of the ultrasonic system.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A multi-channel apparatus, comprising:
a digital-to-analog conversion unit, for generating a plurality of output signals;
an amplification and gain control unit, for receiving a plurality of input signals;
an analog-to-digital conversion unit, coupled to the amplification and gain control unit;
a switching unit, coupled between the digital-to-analog conversion unit and the amplification and gain control unit, having a plurality of channels for outputting the plurality of output signals or for receiving the plurality of input signals; and
a digital transmitting and receiving control unit, coupled between the digital-to-analog conversion unit and the analog-to-digital conversion unit;
wherein in a receiving path test mode, the multi-channel apparatus controls the digital-to-analog conversion unit to enter the receiving path test mode and the channels of the switching unit to receive a plurality of first test signals, and the digital transmitting and receiving control unit, in response to a plurality of test data, corresponding to the plurality of first test signals, outputted from the analog-to-digital conversion unit, performs phase shift correction for the plurality of channels of a receiving path of the multi-channel apparatus.

2. The multi-channel apparatus according to claim 1, wherein in the receiving path test mode, the digital transmitting and receiving control unit outputs the plurality of first test signals.

3. The multi-channel apparatus according to claim 1, wherein in the receiving path test mode, the digital transmitting and receiving control unit disables the digital-to-analog conversion unit.

4. The multi-channel apparatus according to claim 1, further comprising:
a logic unit, for controlling the digital-to-analog conversion unit and the digital transmitting and receiving control unit in the receiving path test mode.

5. The multi-channel apparatus according to claim 1, wherein in a transmitting path test mode, the multi-channel apparatus controls the digital-to-analog conversion unit to output a plurality of second test signals and to output the plurality of second test signals to the amplification and gain control unit via the switching unit, and the digital transmitting and receiving control unit, in response to a plurality of test data, corresponding to the plurality of second test signals, outputted from the analog-to-digital conversion unit, performs phase shift correction for the channels of a transmitting path of the multi-channel apparatus.

6. The multi-channel apparatus according to claim 5, wherein in the receiving path test mode, the digital transmitting and receiving control unit controls the digital-to-analog conversion unit to output the plurality of second test signals.

7. The multi-channel apparatus according to claim 5, further comprising:
a logic unit, for controlling the digital-to-analog conversion unit and the digital transmitting and receiving control unit in the transmitting path test mode.

8. The multi-channel apparatus according to claim 1, wherein the digital transmitting and receiving control unit comprises:
a digital beamforming unit, coupled to the analog-to-digital conversion unit, for outputting a beamforming signal; and
a phase shift correction unit, coupled to the analog-to-digital conversion unit and the digital beamforming unit, for performing phase shift correction for the channels, in response to the plurality of test data outputted from the analog-to-digital conversion unit, to enable the digital beamforming unit to adjust the beamforming signal.

9. The multi-channel apparatus according to claim 8, wherein the digital transmitting and receiving control unit further comprises a serial-to-parallel conversion unit coupled to the analog-to-digital conversion unit, wherein the phase shift correction unit and the digital beamforming unit are coupled to an output of the serial-to-parallel conversion unit, and are also coupled to the analog-to-digital conversion unit via the serial-to-parallel conversion unit.

10. The multi-channel apparatus according to claim 8, wherein the digital beamforming unit comprises:
a beamforming processing unit, for outputting the beamforming signal in response to beamforming parameters of the plurality of channels and the test data outputted from the analog-to-digital conversion unit, and adjusting the beamforming signal according to the beamforming parameters of the plurality of channels and a result of phase shift correction performed by the phase shift correction unit.

11. A hardware phase shift correction method for a multi-channel apparatus, comprising:
providing a multi-channel apparatus, the multi-channel apparatus including a digital-to-analog conversion unit, an amplification and gain control unit, an analog-to-digital conversion unit, a switching unit and a digital transmitting and receiving control unit; wherein the digital transmitting and receiving control unit is coupled between the digital-to-analog conversion unit and the analog-to-digital conversion unit, the switching unit is coupled between the digital-to-analog conversion unit and the amplification and gain control unit, and the amplification and gain control unit is coupled between the switching unit and the analog-to-digital conversion unit;
in a receiving path test mode:
controlling the digital-to-analog conversion unit to enter the receiving path test mode;
receiving a plurality of first test signals through a plurality of channels of the switching unit; and
in response to a plurality of test data outputted from the analog-to-digital conversion unit, performing phase shift correction for the plurality of channels via the digital transmitting and receiving control unit, wherein the plurality of test data correspond to the plurality of first test signals.

12. The hardware phase shift correction method according to claim 11, wherein in the receiving path test mode, the plurality of first test signals are outputted by the digital transmitting and receiving control unit.

13. The hardware phase shift correction method according to claim 12, wherein in the receiving path test mode, the digital-to-analog conversion unit is disabled by the digital transmitting and receiving control unit.

14. The hardware phase shift correction method according to claim 11, wherein after performing phase shift correction for the plurality of channels of the receiving path, the method further comprises:
in a transmitting path test mode:
controlling the digital-to-analog conversion unit to output a plurality of second test signals;
outputting the plurality of second test signals to the amplification and gain control unit via the switching unit; and
in response to a plurality of second test data outputted from the analog-to-digital conversion unit, performing phase shift correction for the plurality of channels by the digital transmitting and receiving control unit, wherein the plurality of test data correspond to the plurality of second test signals.

15. The hardware phase shift correction method according to claim 11, wherein the digital transmitting and receiving control unit outputs a beamforming signal in response to beamforming parameters of the channels and an output of the analog-to-digital conversion unit, and adjusts the beamforming signal according to the beamforming parameters of the channels, the output of the analog-to-digital conversion unit, and a result of phase shift correction performed by the phase shift correction unit.

16. The hardware phase shift correction method according to claim 11, wherein the step of performing phase shift correction for the channels comprises:
k1) calculating coherence of the test data of the channels;
k2) when the coherence of the plurality of test data is smaller than a threshold, performing a calculation of channel phase shift correction, including: adjusting digital data of each of the plurality of channels by advancing or postponing by a delay time value, and calculating coherence of the adjusted digital data of the plurality of channels;
k3) determining whether the coherence of the adjusted digital data of the plurality of channels is greater than or equal to the threshold, and when the coherence of the adjusted digital data of the plurality of channels is greater than or equal to the threshold, utilizing the advanced or postponed delay time value for the different channels as a result of phase shift correction; and
k4) when the coherence of the adjusted digital data of the plurality of channels is smaller than the threshold, step (k3) is iterated until the adjusted digital data of the plurality of channels satisfies the threshold.

17. The hardware phase shift correction method according to claim 16, further comprising:
in response to the result of phase shift correction, updating a beamforming parameter table in the digital transmitting and receiving control unit.

18. The hardware phase shift correction method according to claim 16, further comprising:
in response to the result of phase shift correction, outputting the beamforming signal by the digital transmitting and receiving control unit.

19. A hardware phase shift correction method for a multi-channel apparatus, comprising:
providing a multi-channel apparatus, the multi-channel apparatus including a plurality of analog circuits, for transmitting an analog signal and receiving an echo signal;
in a receiving path test mode:
receiving a plurality of first test signals;
enabling the plurality of first test signals to pass through a plurality of channels of a receiving path of the multi-channel apparatus, and converting the plurality of first test signals to a plurality of test data corresponding to the plurality of first test signals; and
in response to the plurality of test data corresponding to the plurality of first test signals, performing phase shift correction for the plurality of channels.

20. The hardware phase shift correction method according to claim 19, further comprising:
in a transmitting path test mode:
outputting a plurality of second test signals by a circuit of the analog circuits of a transmitting path of the multi-channel apparatus;
enabling the plurality of second test signals to pass through a plurality of channels of the transmitting path of the multi-channel apparatus, and converting the plurality of second test signals to a plurality of test data corresponding to the plurality of second test signals; and
in response to the plurality of test data corresponding to the plurality of second test signals, performing phase shift correction for the plurality of channels.
